(19) United States
(12) Patent Application Publication
(10) Pub. No.: US 2011/0070773 A1
(43) Pub. Date: Mar. 24, 2011

(54) POWER SAVING DEVICE

(76) Inventor: MARK WIRTZ, Overland Park, KS (US)

(21) Appl. No.: 12/889,392

(22) Filed: Sep. 23, 2010

Related U.S. Application Data
(60) Provisional application No. 61/245,053, filed on Sep. 23, 2009.

(51) Int. Cl. H01R 13/60

(52) U.S. Cl. 439/527

(57) ABSTRACT

A power saving device consisting of a strip attachable to the electrical outlet for holding at least one electrical plug in proximity to an electrical outlet, even when the electric plug is not plugged into the electrical outlet, is provided. The strip has flexible two symmetric bow wings. The strip is attached to the electrical outlet by using a securing device, such as a screw, and is provided with at least one vertical groove for securing the electrical cord of the electrical plug to the strip. The strip is made from an electrically insulated resilient material.

### CROSS-REFERENCE TO RELATED APPLICATION

This application claims the benefit of Provisional Patent Application No. 61/245,053 filed on Sep. 23, 2009, in the United States Patent & Trademark Office, the disclosure of which is incorporated herein by reference.

### FIELD OF INVENTION

The present invention relates to power cords organizers. More particularly, the present invention provides device for holding a power plug and cord at a location proximate to an electrical outlet, even when the power plug is not plugged into the electrical outlet.

### BACKGROUND OF THE INVENTION

In most homes and offices, power plugs remain plugged into electrical outlets even when not in use. A most common reason for this is that when plugs or cords are unplugged, they usually end up lying in places (such as behind furniture and the like) which are difficult to access. This makes locating the plugs quickly when required a difficult and frustrating activity. Hence, most people prefer to let power cords be plugged in at all times so that only the action of switching on a corresponding electrical switch is sufficient to make an appliance attached to the power plug operative.

However, there are many reasons which make unplugging a power plug from an electrical outlet, when a corresponding electrical appliance is not in use, desirable. Keeping various cords plugged into an electrical outlet at all times may lead to a rise in one's utility bill, as a quantifiable amount of energy is consumed by the plugged cord even when it is not actively being used to draw out energy. Further, keeping a power cord plugged in at all times may also be a potential fire hazard and may lead to a fire or a short circuit due to overloading of electrical circuits. Hence, it is desirable to store a power plug or cord in a location proximate to an electrical outlet when not in use, in order to facilitate an easy plug in operation.

U.S. Pat. No. 4,921,444, issued on May 1, 1990 to C.C.C. Trading, Inc. describes an electric plug organizer which includes a plug holder formed from a resilient material. The plug holder includes opposed front and rear walls, and opposed side walls all of which define a substantially closed structure having an open top and open bottom surface. An electrical plug not in use may be received within the holder through either the opened top or bottom surface and may be stored therein by frictional engagement with the inner surfaces of the walls of the holder.

Another U.S. Pat. No. 5,547,390, issued on Aug. 20, 1996 to Laherty; Mark E. describes an electrical cord securing device which prevents a plug from being removed from the outlet inadvertently. The device includes a length of material and embodies appendages into which are formed slots. The device is attached to the faceplate of an electrical outlet. An electrical cord is then plugged into the outlet and the cord is wrapped around the device, going through the slots and being held there by friction.

Yet another U.S. Pat. No. 7,230,181, issued on Jun. 12, 2007 to Simmons; Joseph William, et al. describes a device to hold a cord. The device is constructed from a single sheet of resilient material and has a turned end, which is biased towards a first position having a turned orientation. The end may also be forced to an open orientation forming an opening for insertion of a cord into an interior section.

U.S. Pat. No. 7,470,141, issued on Dec. 30, 2008 to Yoest; Daniel T. describes a power cord plug securing device for securely maintaining a power cord plug in electrically operative engagement with an electrical outlet and/or electrical extension cord; thereby, eliminating forced disengagement of same, and the resulting structural and functional damage to the power cord, plug head, and electrical outlet.

Further, U.S. Patent Application 20100038114, dated Feb. 18, 2010 to Honeycutt et al. describes a generally flat cord organizer, defining a strip, having opposite first and second surfaces, a cutout defined therein, said first surface having a plurality of hook fastening components, and said second surface having a plurality of loop fastening components.

Further, U.S. Design Patent D275175, dated Aug. 21, 1984 to Rolli, Jr. describes an electrical cord retainer clip.

Most of the power cord organizers available require setting up extensive appliance which is not convenient to users. Accordingly, there is a need for a simple device that can conveniently be attached to a standard electrical outlet to provide users with an area to hang power cords when not in use so that the cords may easily be accessed when needed. There is also need for a device which would encourage users to keep power cords organized near an electrical outlet without the cords remaining constantly plugged in, thereby leading to saving of money and energy.

Further, there is need for a device which would enable users to not keep various power cords plugged into an electrical outlet at all times thereby raising utility bills and causing fire hazards. Hence, a device for conveniently keeping assorted cords near an electrical outlet, while remaining unplugged while not in use is required. The present invention satisfies these needs, as well as others, and generally overcomes the deficiencies found in the background art.

### SUMMARY OF THE INVENTION

The present invention is directed towards power cord holders and provides a power saving device consisting of a strip attachable to the electrical outlet for holding at least one electrical plug in proximity to an electrical outlet, even when the electric plug is not plugged into the electrical outlet.

In various embodiments of the present invention, a power saving device for holding at least one electrical plug in proximity to an electrical outlet is provided. The power saving device comprises a strip attachable to the electrical outlet, the strip comprising at least one vertical groove for securing the electrical plug to the strip, the strip being attached to the electrical outlet by using a securing device. The strip has two symmetric bow wings

In an embodiment, the strip is made from an electrically insulated resilient material or plastic so the two bow wings are flexible. Further, in an embodiment, each of the vertical grooves in the strip comprises one or more prongs for securely holding a cord attached to the electric plug, the cord being pushed between the one or more prongs for secure holding.

Yet further, in an embodiment, the strip is attached to a cover plate of the electrical outlet by using a screw, the screw being removed from the cover plate before attachment, the screw being reinserted into the cover plate through a hole provided on the strip.

Hence, in an embodiment, the power saving device of the present invention holds at least one electrical plug in proximity to an electrical outlet when the electric plug is not plugged into the electrical outlet. In another embodiment, the power saving device of the present invention holds at least one electrical plug in proximity to an electrical outlet when the electric plug is plugged into the electrical outlet.

### BRIEF DESCRIPTION OF THE ACCOMPANYING DRAWINGS

The present invention is described by way of embodiments illustrated in the accompanying drawings wherein:

FIG. 1 illustrates the power saver device coupled with an electrical outlet, in accordance with an embodiment of the present invention;

FIG. 2 illustrates the power saver device holding power plugs, in accordance with an embodiment of the present invention;

FIG. 3A illustrates the power saver device, in accordance with an embodiment of the present invention;

FIG. 3B illustrates the power saver device, in accordance with an embodiment of the present invention;

FIG. 4 illustrates the power saver device, in accordance with another embodiment of the present invention;

FIG. 5A illustrates a usage scenario of the power saver device where power plugs held by the device are not being used for operating a corresponding electrical appliance, in accordance with an embodiment of the present invention; and

FIG. 5B illustrate a usage scenario of the power saver device where power plugs held by the device are being used for operating a corresponding electrical appliance, in accordance with an embodiment of the present invention.

### DETAILED DESCRIPTION OF THE INVENTION

A power saving device which enables organization of power plugs and cords at a location proximate to an electrical outlet is described herein. The present invention provides a device attachable to an electrical outlet for holding power plugs and cords close to the electrical outlet even when the power plugs are not being used. In an embodiment of the present invention, the power saving device is modeled as a strip made of an electrically insulated resilient material or plastic so the two bow wings are flexible. The strip may be attached to a face plate of an electrical outlet by using a securing mechanism such as a screw. In an embodiment, the strip is provided with one or more vertical grooves for holding a power cord attached to a power plug. As would be apparent to a person of ordinary skill in the art, various other methods may be used for attaching a power cord or plug to the strip. Hence, the device of the present invention encourages removal of power plugs from electrical outlets when not in use, thereby leading to power saving.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

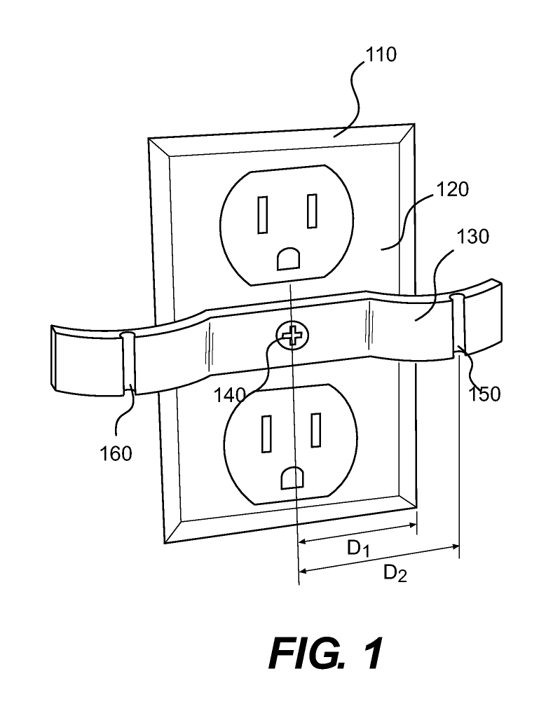

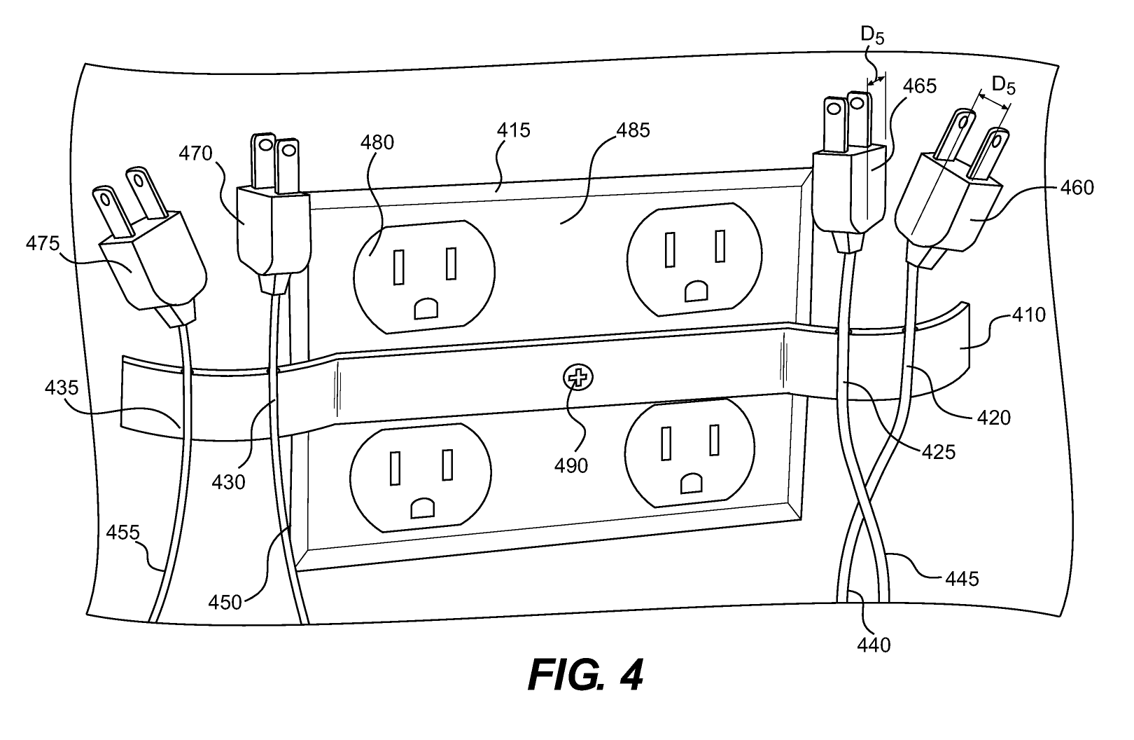

FIG. 1 illustrates the power saver device coupled with an electrical outlet, in accordance with an embodiment of the present invention. FIG. 1 illustrates an electrical outlet 110 comprising a plate cover 120. The power saver device of the present invention which is strip 130 is coupled with the electrical outlet 110 by means of screw 140. The strip 130 is provided with a hole through which the screw 140 is inserted into a corresponding hole in the plate cover 120 and tightened for attaching the strip 130 to the plate cover 120 (with the width is about 3.5 inches). The width of the strip 130 is less than the distance between the two outlets. The trip 130 has two flexible symmetric bow wings. The strip 130 is provided with vertical grooves 150 and 160 for holding the power cords of power plugs vertically which require to be used in conjunction with the electrical outlet 110. The distance between the center of the screw 140 and the edge of the cover 120 is D₁ (about 1.75 inches). The distance between the center of the screw 140 and the edge of the vertical groove 150 is D₂, which is larger than then distance D₁. The optimum distance is D₂=D₁+D₅ (D₅ is half size of the plug 220 or plugs 460, 465 in FIG. 4). If distance D₂ is too long, then it is a big waste on material. If distance D₂ is too short, then there is an interfere with a plug socket (e.g. 480 in FIG. 4). So, the location of the vertical groove is outside the electrical outlet area.

In an embodiment the strip 130 is approximately 1″ high (W), 5″ to 8″ long and ½″ wide and is made of plastic. In other embodiments, various other suitable materials and dimensions may be used to construct the strip 130 and the number of power cords that can be held by the strip 130 may vary to accommodate user preferences and needs. Further, the strip 130 may be manufactured in assorted colors and designs. A customize logo, sport logo, company name, decorative designs can be printed on the strip 130.

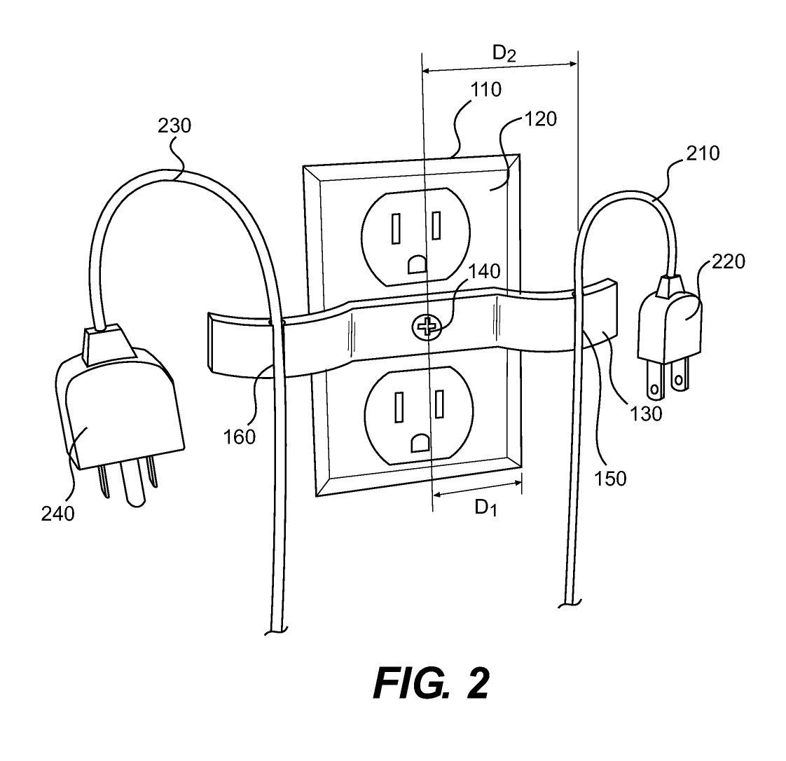

FIG. 2 illustrates the power saver device holding power plugs, in accordance with an embodiment of the present invention. The figure illustrates the vertical grooves 150 and 160 holding power cords 210 and 230 respectively, which in turn are attached to power plugs 220 and 240. In an embodiment, the vertical grooves 150 and 160 are each provided with a pair of prongs through which the power cords 210 and 230 are pushed in and held securely. In other embodiments, various other means to hold the power cords 210 and 230 securely in the vertical grooves 150 and 160 may be used.

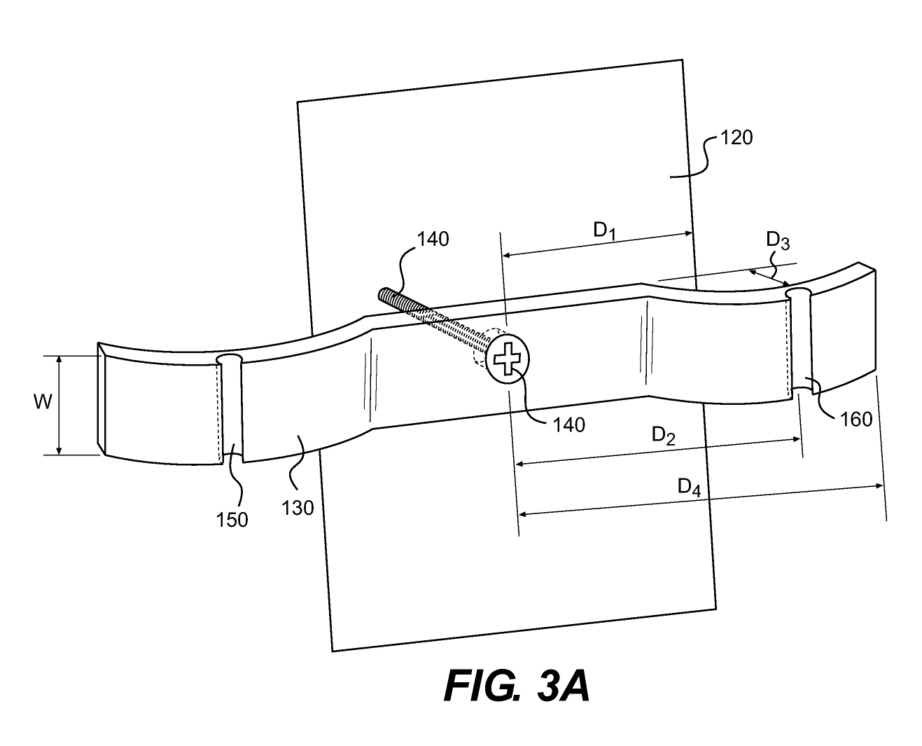

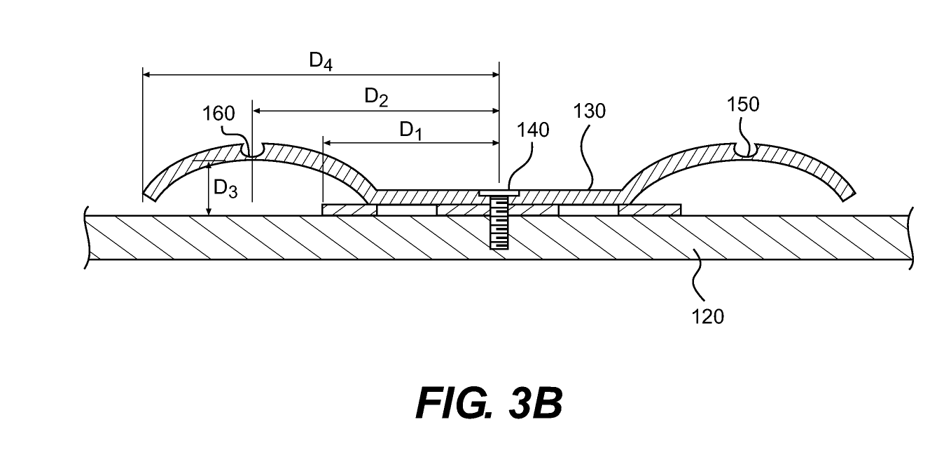

FIG. 3A illustrates the power saver device, in accordance with an embodiment of the present invention. The strip 130 is provided with a centered hole 310 for insertion of the screw 140. In an embodiment, firstly the screw 140 is removed from a traditional plate cover of an electrical outlet exposing a hole in the plate cover, secondly the strip 130 is placed over the plate cover in a manner so that the hole 310 in the strip 130 and that in the plate cover are aligned, and thirdly the screw 140 is inserted through the aligned holes and screwed back on, securing the strip 130 to the plate cover. The distance between the center of the screw 140 and the edge of the strip 130 is D₄ (D4 is about D1 plus 1 inch). The distance between the wall and back of vertical groove 150 is D₃, which is larger than half-size of the plug D₅ (D₅ is half size of the plug 220 or plugs 460, 465 in FIG. 4). If distance D₃ is D₅, then there is an interfere with a plug socket (e.g. 480 in FIG. 4) with the wall. So, the location of the vertical groove 150 is outside the electrical outlet area.

FIG. 3B illustrates a cross-section of the power saver device, in accordance with an embodiment of the present invention. The strip 130 is provided with a centered hole for insertion of the screw 140. In an embodiment, firstly the screw 140 is removed from a traditional plate cover of an electrical outlet exposing a hole in the plate cover, secondly the strip 130 is placed over the plate cover in a manner so that the centered hole in the strip 130 and that in the plate cover are aligned, and thirdly the screw 140 is inserted through the aligned holes and screwed back on, securing the strip 130 to the plate cover. The distance between the center of the screw 140 and the edge of the cover 120 is D₁ (about 1.75 inches). The distance between the center of the screw 140 and the edge of the vertical groove 150 is D₂, which is larger than then distance D₁. The optimum distance is D₂=D₁+D₅ (D₅ is half size of the plug 220 or plugs 460, 465 in FIG. 4). If distance D₂ is too long, then it is a big waste on material. If distance D₂ is too short, then there is an interfere with a plug socket (e.g. socket 480 in FIG. 4). The distance between the center of the screw 140 and the edge of the strip 130 is D₄ (D4 is about D1 plus 1 inch). The distance between the wall and back of vertical groove 150 is D₃, which is larger than half-size of the plug D₅ (D₅ is half size of the plug 220 or plugs 460, 465 in FIG. 4). If distance D₃ is D₅, then there is an interfere with a plug socket (e.g.

socket 480 in FIG. 4) with the wall. The distance D₃ helps the plug to get off the wall. So, the location of the vertical groove 150 is outside the electrical outlet area. The distance D₃ helps the plug to get off the wall.

FIG. 4 illustrates the power saver device, in accordance with another embodiment of the present invention. As illustrated, the power saver device which is strip 410 is attached to an electrical outlet 415 is provided with four vertical grooves 420, 425, 430 and 435 to hold power cords 440, 445, 450 and 455 respectively. The power cords 440, 445, 450 and 455 are in turn connected to power plugs 460, 465, 470 and 475 respectively which when in operation are inserted in any of the plug sockets 480. The strip 410 is secured to a plate cover 485 of the electrical outlet 415 by means of a screw 490.

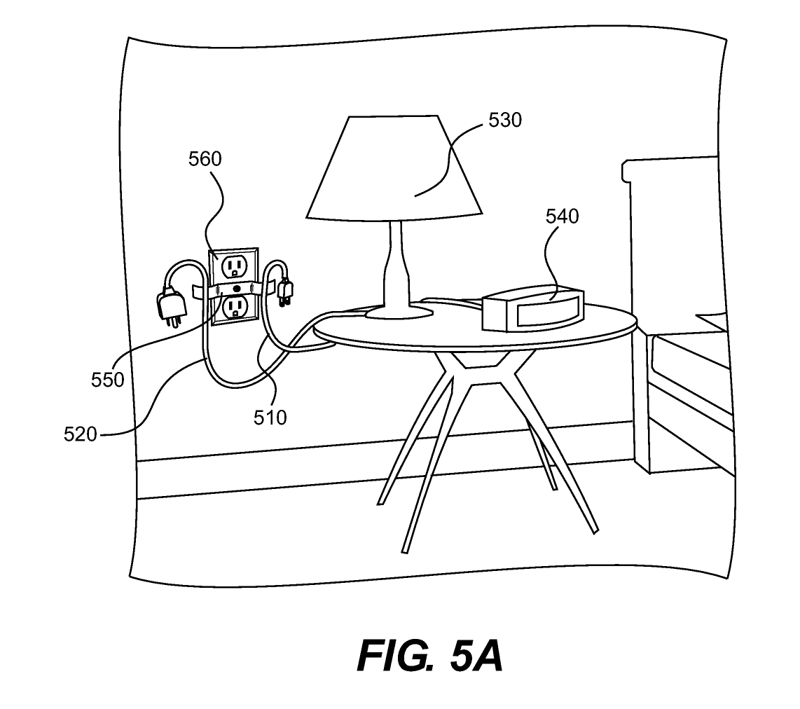

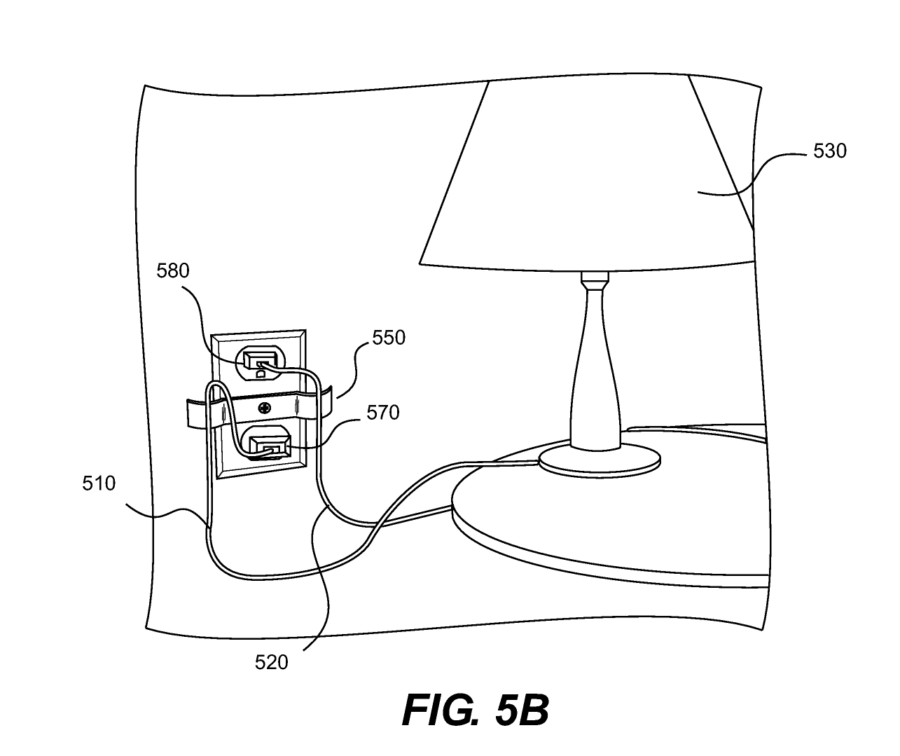

FIG. 5A illustrate a usage scenario of the power saver device when power plugs held by the device are not being used for operating a corresponding electrical appliance, in accordance with an embodiment of the present invention. As illustrated, the power cords 510 and 520 attached to lamp 530 and alarm clock 540 are securely held on to strip 550 attached to electrical outlet 560, when not in use.

FIG. 5B illustrate a usage scenario of the power saver device when power plugs held by the device are being used for operating a corresponding electrical appliance, in accordance with an embodiment of the present invention. As illustrated, the power cords 510 and 520 attached to lamp 530 and alarm clock 540 are inserted in plug sockets 570 and 580 respectively, during use. In the embodiment illustrated in FIG. 5B, the power cords 510 and 520 are securely held on to strip 550 during use as well. In another embodiment, the power cords 510 and 520 may be detached from the strip 550 before insertion in the plug sockets 570 and 580 respectively.

Therefore the present invention provides a power saving device that can be coupled with a standard electrical outlet to provide users with an area to hang power cords when not in use so that the cords may easily be accessed when needed. The novel and environmentally conscious device provided by the present invention assists users in lowering power bills by completely removing the cords of appliances so that the appliances do not receive any power, when not in use. The power saving device is ideal for use in private residences as well as commercial establishments to keep power cords organized near an electrical outlet without remaining constantly plugged in, thereby saving money and energy.

While the exemplary embodiments of the present invention are described and illustrated herein, it will be appreciated that they are merely illustrative. It will be understood by those skilled in the art that various changes in form and detail may be made therein without departing from or offending the spirit and scope of the invention as defined by the appended claims.

What is claimed is:

1. A power saving device for holding at least one electrical power plug in proximity to an electrical outlet plate cover having two outlets, the power saving device comprising:
a strip has two symmetric bow wings and the width of the strip is less than the distance between the two outlets.
each of bow wing has at least one vertical groove for securing the electrical cord of the electrical power plug to the strip, wherein the location of the vertical groove is outside the electrical outlet area;
each of the bow wing has a distance between the wall and back of vertical groove is D₃, which is larger than half-size of the plug so the plug does not touch the wall, and
a screw is used to secure the strip to the center of electrical outlet.

2. The power saving device as claimed in claim 1 wherein the strip is made from an electrically insulated resilient material so the two bow wings are flexible.

3. The power saving device as claimed in claim 1 wherein the strip is made of plastic so the two bow wings are flexible.

4. The power saving device as claimed in claim 1 wherein each vertical groove in the strip comprises one or more prongs for securely holding a cord attached to the electric plug, the cord being pushed between the one or more prongs for secure holding.

5. The power saving device as claimed in claim 1 wherein the screw being removed from the cover plate before attachment, the screw being reinserted into the cover plate through a hole provided on the strip.

6. The power saving device as claimed in claim 1 holding at least one electrical plug in proximity to an electrical outlet when the electric plug is not plugged into the electrical outlet.

7. The power saving device as claimed in claim 1 holding at least one electrical plug in proximity to an electrical outlet when the electric plug is plugged into the electrical outlet.

8. The power saving device as claimed in claim 1, wherein a customize logo, sport logo, company name, decorative designs can be printed on the strip.
